(19) United States
(12) Patent Application Publication
(10) Pub. No.: US 2016/0093121 A1
(43) Pub. Date: Mar. 31, 2016

(54) DRIVING EVENT NOTIFICATION

(71) Applicant: Y3K (EUROPE ) LIMITED, Croydon, Surrey (GB)

(72) Inventor: Paul SINGH, Croydon (GB)

(73) Assignee: Y3K (Europe) Limited, Croydon (GB)

(21) Appl. No.: 14/891,227

(22) PCT Filed: May 13, 2014
(86) PCT No.: PCT/GB2014/051467

§ 371 Date: Nov. 13, 2015

(30) Foreign Application Priority Data
May 14, 2013 (GB) 1308671.5

(51) Int. Cl. G07C 5/00; H04W 4/22; H04L 12/58; G07C 5/08

(52) U.S. Cl. CPC G07C 5/008; G07C 5/0866; H04W 4/22; H04L 51/04

(57) ABSTRACT

A driving event notification device is described, and comprises an accelerometer for detecting forces experienced by a vehicle, a positioning device for determining the position of the vehicle, and a camera for generating image data. A processor is provided, for detecting the occurrence of a driving event by comparing the outputs of one or both of the accelerometer and the positioning device with at least one rule. A communications port is provided, for establishing a connection with the Internet and an email handler uses an email address dedicated to the driving event notification device, for generating a reporting email containing event information concerning the detected event and image data generated by the camera at or around the time of occurrence of the detected event, and sending the reporting email over the Internet via the communications port to a destination email address. The processor is responsive to the detection of the occurrence of the event to cause the email handler to generate the reporting email and send it over the Internet to the destination email address. By providing the notification device with a dedicated email address and communicating detected events by email to a destination email address, there is no need to provide a fixed IP address for the notification device, or to provide a reliable machine-to-machine communications session between the notification device and a remote server. A conventional link to the Internet (e.g. via 3G) can be established, and reporting emails sent as and when events are detected at the notification device. Further, by providing image data in association with an event, confirmation of the nature of the event can be made, enabling “false” events to be identified and disregarded.

### FIELD OF THE INVENTION

The present invention relates to driving event notification. Embodiments of the invention relate to a driving event notification device, a driving event notification method, an event detection server, a false event detection server, an event handling system and a computer program.

### BACKGROUND OF THE INVENTION

Vehicle accident event cameras are widely available and consist of a windscreen mounted device that contains the following:
G-force sensor: To record the forces being placed on the vehicle, such as acceleration, braking, left/right and up/down, both during driving and during an accident.
Microphone: To record audio from both inside and outside the vehicle.
Camera: To record the driver's view of the road.
GPS receiver: To show the vehicle speed (according to GPS), the direction of travel and the location of the vehicle.
Recordings of the above are made on to flash memory (SD Card, USB, Micro SD etc. . . . ), which must then be removed and played back Current vehicle accident event recorders have some disadvantages:
To view the data recorded by them, the flash memory (SD Card, USB, Micro SD etc) has to be removed and then played back on a computer.
They do not offer instant notification of accidents; they rely on the driver to report when an accident or other event occurs.
Once the flash memory (SD Card, USB, Micro SD etc. . . . ) is removed from the device no further recordings can take place unless it is replaced.
The recording time is limited by the size of the flash memory (SD Card, USB, Micro SD etc).
Flash memory (SD Card, USB, Micro SD etc) has a limited life time—they are a consumable.
Live information of G-forces, speed and location (GPS) of the vehicle are not available, so unless an accident or event occurs it is not possible to detect issues with drivers.
No clear indication of driving style to driver

### SUMMARY OF THE INVENTION

According to an aspect of the invention, there is provided a driving event notification device, comprising:

an accelerometer for detecting forces experienced by a vehicle;

a positioning device for determining the position of the vehicle;

a camera for generating image data;

a processor, for detecting the occurrence of a driving event by comparing the outputs of one or both of the accelerometer and the positioning device with at least one rule;

a communications port, for establishing a connection with the Internet; and

an email handler using an email address dedicated to the driving event notification device, for generating a reporting email containing event information concerning the detected event and image data generated by the camera at or around the time of occurrence of the detected event, and sending the reporting email over the Internet via the communications port to a destination email address;

wherein the processor is responsive to the detection of the occurrence of the event to cause the email handler to generate the reporting email and send it over the Internet to the destination email address.

By providing the notification device with a dedicated email address and communicating detected events by email to a destination email address, there is no need to provide a fixed IP address for the notification device, or to provide a reliable machine-to-machine communications session between the notification device and a remote server. A conventional link to the Internet (e.g. via 3G) can be established, and reporting emails sent as and when events are detected at the notification device. Further, by providing image data in association with an event, confirmation of the nature of the event can be made, enabling “false” events to be identified and disregarded. It will therefore be appreciated that an instant video notification accident event recorder and tracker can be provided, thereby reducing the disadvantages with existing systems referred to above.

Because email can be automatically delivered to a device as soon as that device becomes connected to the Internet, it does not matter if connectivity is lost occasionally. The device will merely pick up the email when it reconnects with the Internet. The sending device does not need to know whether the notification device is currently able to receive emails or not. It will be appreciated that in the current application the vehicle may sit dormant on a driveway, or in a car park or garage, for extended periods, and that the notification device may either be switched off or in a sleep mode during this time. Emails sent from an external device to the notification device may therefore not be picked up by the notification device for some time.

According to another aspect of the present invention, there is provided a driving event notification device, comprising: an accelerometer for detecting forces experienced by a vehicle;

a positioning device for determining the position of the vehicle;

a camera for generating image data;

a communications port, for establishing a connection with the Internet; and

an email handler using an email address dedicated to the driving event notification device, for generating a reporting email containing the outputs of one or both of the accelerometer and the positioning device and image data generated by the camera at or around the time of output of the outputs of the accelerometer and/or the positioning device, and sending the reporting email over the Internet via the communications port to a destination email address.

Similarly to the previous aspect, by providing the notification device with a dedicated email address and communicating by email to a destination email address, there is no need to provide a fixed IP address for the notification device, or to provide a reliable machine-to-machine communications session between the notification device and a remote server. A conventional link to the Internet (e.g. via 3G) can be established, and reporting emails sent either periodically or on request. Further, by providing image data in the reporting emails, confirmation of the nature of any event can be made, enabling “false” events to be identified and disregarded.

The processor may be responsive to the receipt of a control email addressed to the dedicated email address and received at the email handler over the Internet to initiate or control a function of the notification device. In this way, the notification device can be controlled via email as well as reporting via email In other words, all communications to and from the notification device can potentially be carried out via email

The notification device may comprise an attachment part arranged to receive a detachable communications dongle. In this case, the communications port is operable to use the communications dongle to establish the connection with the Internet. The attachment part may be a conventional USB or serial connector, permitting off-the-shelf wireless dongles to be purchased and used to establish an Internet connection over which emails can be sent and received by the notification device. Such off-the-shelf wireless dongles may have a data usage agreement which is much cheaper and more generous with data allowances than the usage agreements typically provided for dedicated M2M type communication.

The notification device may comprise a data store for storing the outputs of the accelerometer and the positioning device, and the image data generated by the camera. The processor may be responsive to a request received by email at the email handler to obtain the stored outputs and image data corresponding to a time period specified in the request email, and to cause the email handler to generate and send to a target email address a reporting email containing the requested stored outputs and image data. The request email may specify an image resolution, and the processor may cause the email handler to generate and send to a target email address a reporting email containing the requested image data at the requested resolution.

While the camera device may only capture still images, preferably the camera device is operable to capture a video recording of a scene. In this case, the request email may specify a frame rate, and the processor may cause the email handler to generate and send to a target email address a reporting email containing the requested video recording at the requested frame rate.

The reporting email may carry a reduced quality version of image data captured by the camera at or around the time of occurrence of a detected event. This reduces the amount of data to be transmitted. The reduced quality version of the image data may be one or more of reduced in resolution, reduced in frame rate, and at a higher level of compression. In order to provide a higher quality version of the image data when it is needed, the processor may be responsive to the receipt at the email handler of a request for a higher quality version of the image data sent in the reporting email, to cause the email handler to generate and send a further reporting email carrying a higher quality version of the image data sent in the reporting email. For evidence purposes, the higher quality version of the image data may be one or both of watermarked and time/date stamped. In other words, the notification device can be set up to send compressed video (for example) to an recipient automatically when an event occurs, and then when this is verified by the recipient as being a real event, by simply replying to the notification device by email address, the unit will be caused to send the original high resolution video

Preferably, the camera device is mounted to capture a scene similar to that viewed by the driver of the vehicle to which the notification device is mounted. For example, the camera device may be mounted to the windscreen. Additional camera devices may be provided to give different views, potentially providing all-round external (and possibly internal) coverage.

Many different types of events may be detected (either at the notification device or externally of the notification device based on the data in reporting emails sent by the notification device). For example, an event may be detected when the accelerometer outputs a value which satisfies a threshold condition specified in the at least one rule. The event may be a collision, and the collision event may be detected when the accelerometer outputs a value which exceeds a collision threshold. Alternatively, the event may be an incident of aggressive driving, and the aggressive driving event may be detected when the accelerometer outputs one or more values which exceed an aggressive driving threshold (which can be expected to be lower than the collision threshold).

The accelerometer may output separate values for each of a first axis which is substantially parallel to a front-to-back axis of the vehicle, a second axis which is substantially parallel with a left to right axis of the vehicle and a third axis which is substantially parallel with an up-down axis of the vehicle. A type of event detected may be dependent on in relation to which of the first axis, second axis and third axis a threshold condition (which may be different for each axis) is satisfied. In some cases, the threshold condition may be dependent on the speed of the vehicle.

The positioning device may determine one or more of the speed of the vehicle, the direction of travel of the vehicle and the position of the vehicle. An event may be detected when the speed of the vehicle is determined from the output of the positioning device to exceed a threshold value specified in the at least one rule. The threshold value may be based on a speed limit for a road on which the vehicle is determined to be driving based on the current position of the vehicle as reported by the positioning device and map data indicating a speed limit for roads.

The event may be the unauthorised movement of the vehicle, detected based on one or both of the location of the vehicle and the time the vehicle is being driven.

The notification device may comprise a 2 way audio device which is operable to establish a voice channel to the driver via the communications port and the Internet. This enables the device to comply with eCall legislation while using only a single communications channel for both voice calls and the communication of emails to and from the notification device.

The reporting email may be a text email comprising one or more of the vehicle registration number, an indication of the detected event, and a date/time of occurrence of the detected event. The subject line of a reporting email may indicate the vehicle to which the report relates, while the subject line of an email being sent to the notification device may specify a function to be carried out (with the body of the email potentially being blank in the latter example).

The notification device may comprise a driving style indicator, and the processor may control the driving style indicator to display to the driver an indication of their current driving style based on the output of the accelerometer.

The processor may be operable to cause the email handler to generate and send a reporting email indicating a current location of the vehicle at predetermined time intervals.

This enables the location of the vehicle to be tracked. Alternatively, the processor may be responsive to a location requesting email received at the email handler to cause the email handler to generate and send a reporting email indicating a current location of the vehicle. In other words, the location can be provided under either a “push” or “pull” arrangement.

The processor may be responsive to a firmware update received via email at the email handler to update the firmware of the notification device using the firmware update. Similarly, the processor may be responsive to a settings update control email to update software or hardware settings of the notification device. The software settings may comprise the rules used to determine whether an event has occurred.

If a connection with the Internet cannot be established by the communications port, the processor may be operable to cause detected events and/or the outputs of the accelerometer and positioning device to be buffered until a connection with the Internet can be re-established.

If a confirmation receipt email is not received at the email handler from the destination email address within a predetermined time period from when a reporting email is sent, the email handler may be operable to resend the reporting email.

The notification device may comprise a tamper switch, and the processor may be responsive to the actuation of the tamper switch to cause the email handler to generate and send a tamper alert email to a destination email address.

The notification device may comprise an identification device for verifying the identity of a driver of the vehicle. The processor may be operable to cause the email handler to generate and transmit an alert email if an unauthorised person enters or attempts to drive the vehicle. Various types of identification device can be envisaged, for example an inwards facing camera with facial recognition could be used. Preferably though, the identification device is an RFID reader, and the identification device verifies the identity of the driver of the vehicle based on the detection of an RFID card or tag carried by the driver.

According to another aspect of the present invention, there is provided a false event detection server for receiving reporting emails from a notification device according to the first aspect as described above, the false event detection server being associated with the destination email address, the false event detection server comprising:

an email handler using the destination email address; and

a processor, operable to compare the event information in the reporting email with a client event definition to determine whether the event information relates to a real event or a false event, and to cause the email handler to forward the reporting email to a client email address only if the reporting email is determined to be a real event.

The reporting email received at the email handler of the false event detection server may carry image data at a reduced quality, and the processor of the false event detection server may be operable, when the event information in the reporting email is determined to relate to a real event, to send an email request to the notification device to provide a higher resolution version of the image data corresponding to the event.

According to another aspect of the present invention, there is an event detection server for receiving reporting emails from a notification device according to the second aspect as described above, the event detection server being associated with the destination email address, the event detection server comprising:

an email handler using the destination email address; and

a processor, operable to detect the occurrence of a driving event by comparing the accelerometer and/or positioning device outputs carried in the reporting email with at least one rule.

The reporting email received at the email handler of the false event detection server may carry a video image at a reduced resolution, and the processor of the false event detection server may be operable, when an event is detected in the accelerometer and/or positioning device outputs carried in the reporting email, to send an email request to the notification device to provide a higher resolution version of the video image corresponding to the event.

According to another aspect of the present invention, there is provided an event handling system, configured to receive reporting emails from a notification device as described above. The system may be operable to identify the notification device based on the dedicated email address from which the reporting email is received.

According to another aspect of the present invention, there is provided a driving event notification method, comprising the steps of:

detecting forces experienced by a vehicle;

determining the position of the vehicle;

generating image data;

detecting the occurrence of a driving event by comparing the detected forces and/or the determined position with at least one rule;

establishing a connection with the Internet; and

using an email address dedicated to the driving event notification device, generating a reporting email containing event information concerning the detected event and image data generated at or around the time of occurrence of the detected event, and sending the reporting email over the Internet to a destination email address;

wherein the generation and sending of the reporting email is responsive to the detection of the occurrence of the event.

According to another aspect of the present invention, there is provided a driving event notification method, comprising the steps of:

detecting forces experienced by a vehicle;

determining the position of the vehicle;

generating image data;

establishing a connection with the Internet; and

using an email address dedicated to the driving event notification device, generating a reporting email containing the detected forces and/or the position of the vehicle and image data generated at or around the time of detection of the forces and/or the determined vehicle position, and sending the reporting email over the Internet to a destination email address.

The driving event notification method may further comprise the steps of:

receiving the reporting email at the destination email address; and

detecting the occurrence of a driving event by comparing the detected forces and/or the vehicle position carried in the reporting email with at least one rule.

Further aspects and features of the present invention are also envisaged, and include a computer program.

### BRIEF DESCRIPTION OF THE DRAWINGS

Embodiments of the present invention will now be described with reference to the following drawings, in which:

FIG. 1 schematically illustrates a driving event notification system according to an embodiment of the present invention;

FIGS. 2A and 2B schematically illustrate a two-unit structure for a driving event notification device according to an embodiment of the present invention;

FIG. 3 is a schematic signal flow diagram describing the communication of emails between a notification device, a false event detection server, and a client device;

FIG. 4 is a schematic signal flow diagram describing the use of acknowledgement emails;

FIG. 5 is a schematic signal flow diagram describing the use of notification request emails to trigger the notification device to send a reporting email;

FIG. 6 is a schematic signal flow diagram describing the use of control emails to trigger functions at the notification device;

FIG. 7 is a schematic signal flow diagram describing the use of an update email to trigger an update at the notification device;

FIG. 8 is a schematic signal flow diagram describing the use of a location request email to track the location of a vehicle; and

FIG. 9 is a schematic signal flow diagram describing the use of periodic reporting email updates initiated by the notification device.

### DESCRIPTION OF THE EXAMPLE EMBODIMENTS

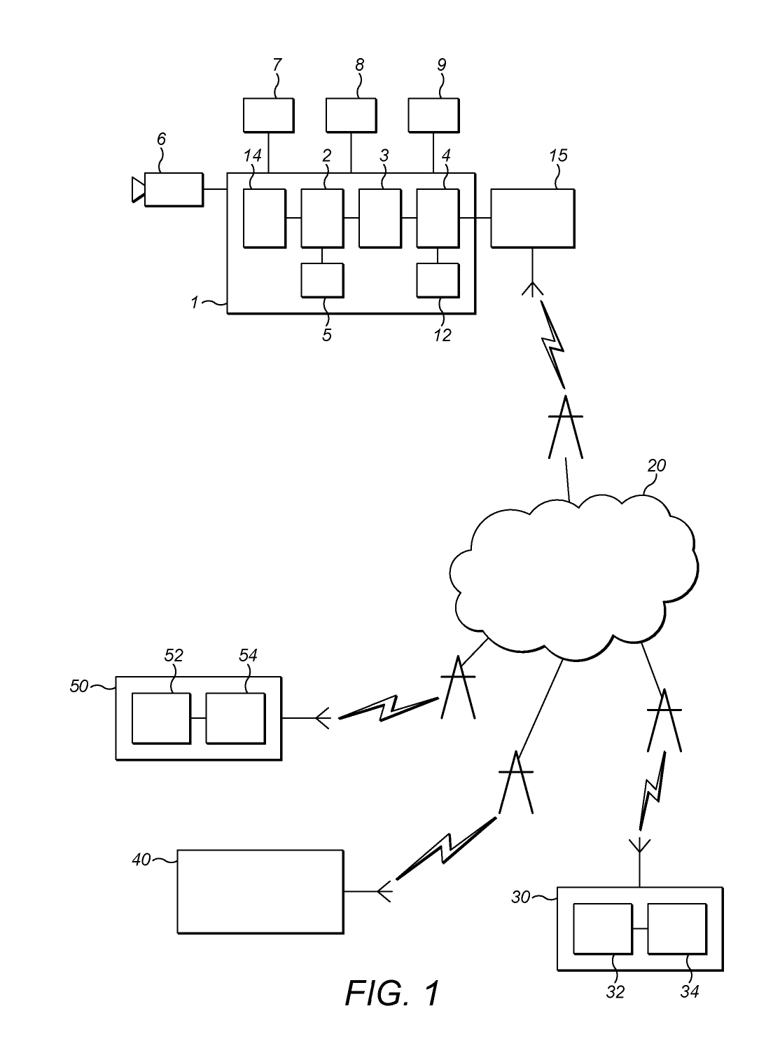

Referring to FIG. 1, a driving event notification system is schematically illustrated. The driving event notification system comprises a driving event notification device 1. The driving event notification device 1 comprises a camera 6 (which may be a still camera or more preferably a video camera) for capturing images of a scene as viewed by the driver of a vehicle, an accelerometer 7 for detecting acceleration forces applied to the vehicle to which the driving event notification device 1 is fitted, a positioning device 8 (such as a GPS receiver) for determining a current geographical location of the vehicle, and an RFID reader 9 for determining whether the vehicle is being driven by an authorised person. The vehicle event notification device 1 also comprises a processor 2 for processing the inputs from the camera 6, accelerometer 7, positioning device 8 and RFID reader 9 to detect driving events such as speeding (based on a speed output of the positioning device 8 or the position over time reported by the positioning device 8), aggressive driving (based on acceleration forces measured by the accelerometer 7), and collisions (based on very high forces measured by the accelerometer 7). The processor 2 also controls the operation of the driving event notification device 1, including the reporting of events to an external device (see below). The notification device can use the RFID reader 9 to verify the identity of a driver or to email an alert when an unauthorised person enters the vehicle. The unauthorised person can be detected for instance when the vehicle is started up when the RFID reader is not able to read a known card or tag. The processor 2 may make use of a data store 5 (memory or recording medium) for storing image and other data, and is able to control the generation of reporting emails carrying event-related data and/or outputs from the accelerometer 7 and positioning device 8 at an email handler 3. The email handler 3 is both able to send and receive emails, and uses a dedicated and unique email address associated with the vehicle event notification device 1. The email address may be allocated on manufacture or setup, and may comprise a unique identification number or code prefix. The email handler 3 may be a software function run on the processor 2. The vehicle event notification device 1 also comprises a communications port 4 for establishing a connection with the Internet 20. The connection with the Internet 20 is provided by way of a communications dongle 15, which may be an off-the-shelf communications dongle which the vehicle event notification device 1 is able to receive in a

USB or serial slot for example, and which can be used to communicate via the Internet 20. A 2-way audio component 12 is also provided for permitting voice communication between the driver and a third party, for example the emergency services or an insurance company,in the event of an accident. The 2-way audio component 12 (comprising a microphone and speaker) can use the communications port 4 and the same Internet connection as provided for email notification. The 2-way audio facility enables the device to support the new eCall legislation. A driving style indicator 14 is also provided, and is controlled by the processor to provide the driver with an indication of how aggressively they are driving, as determined by the output of the accelerometer 7.

Also attached to the Internet is an event handling system 30, a driver's personal device 40 and a false event detection server 50. Each of the devices 30, 40, 50 communicate with the driver event notification device 10 entirely by email. No dedicated communications channel or session between any of these devices and the driver event notification device 1 is required. The event handling device 30 comprises an email handler 32 for sending emails to and receiving emails from the dedicated email address of the driver event notification device 1, and a processor 34 for handling the data received by email from the driver event notification device 1 at the email handler 32. The processor 34 also generates control instructions for controlling the operation of the driver event notification device 1, the control instructions being provided to the driver event notification device 1 in email form by the email handler 32. Similarly, the false event detection server 50 comprises an email handler 52 for sending emails to and receiving emails from the dedicated email address of the driver event notification device 1, and a processor 54 for handling the data received by email from the driver event notification device 1 at the email handler 52. The processor 54 generates control instructions for controlling the operation of the driver event notification device 1, the control instructions being provided to the driver event notification device 1 in email form by the email handler 52. The driver's personal device 40 may be any device—smartphone, personal computer, tablet computer etc—capable of receiving emails from the driver event notification device 1. The driver may be emailed to inform him that he is in breach of driving restrictions placed on him by his insurance company.

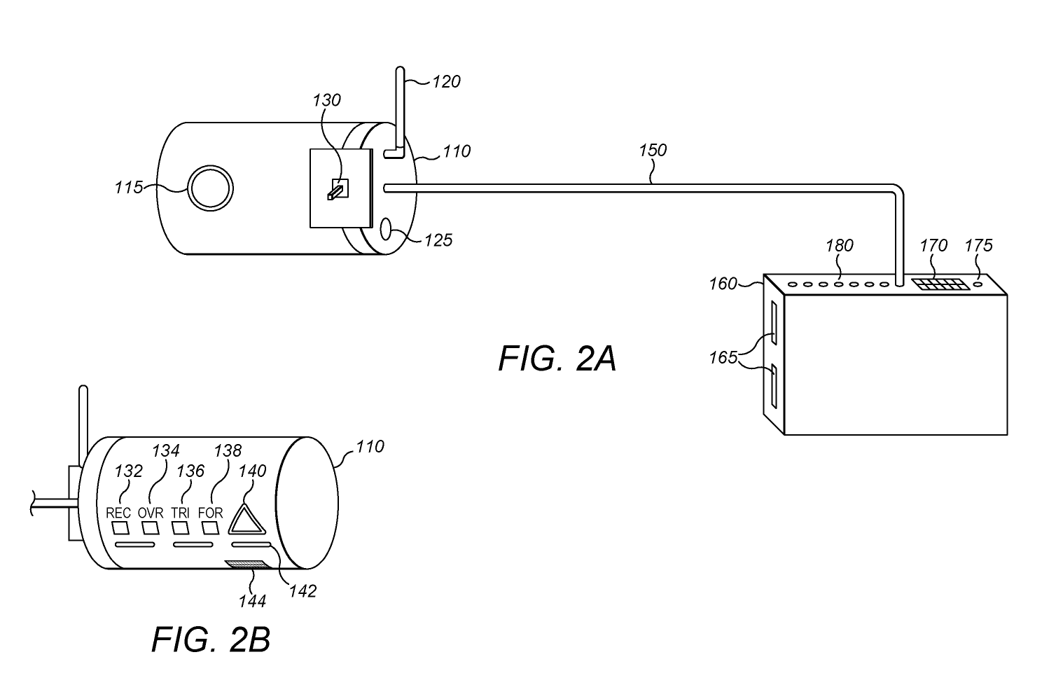

Referring to FIG. 2A, a two part design of the driver event notification device 1 of FIG. 1 is schematically illustrated. The device has two parts—a first unit 110 for mounting on the windscreen of a vehicle and a second unit 160 providing a central control box to be hidden under the dashboard of the vehicle (for example). The two parts are connected together via a connection cable 150. The first unit 110 comprises a full HD camera with 170° lens 115 for capturing an image (still or video) of a scene. The camera 115 is forward facing when the first unit 110 is mounted to a windscreen. An antenna 120 is provided for permitting communication via the Internet. A second camera input 125 is also provided, permitting a further camera to be coupled to the device 1. The additional camera could be used to provide a view out of the rear of the vehicle (to witness another vehicle striking from the rear) or another external view, or to provide a view of the interior of the car—for example of the driver (perhaps to see if the driver is paying attention to the road). A tamper switch 130 is also provided, causing an alarm and/or email notification to be triggered if an attempt is made to remove the first unit 110 from the windscreen. Internal to the first unit 110 are a GPS receiver, an RFID reader and a 3 axis G force/shock sensor (accelerometer).

The second unit 160 comprises a dual SD card slot 165 for receiving memory cards for providing storage for the image data and other data generated by the device. The 2 flash memory slots may be additional to an on board memory, and will record all data from the unit and act as a backup should the telemetry communication ever fail or not be present. The two cards can optionally be set up to mirror each other, to provide redundancy in the event of a card failure. Alarm inputs and outputs 170 (8 alarm inputs and 2 alarm outputs) are provided, permitting events to be triggered by inputs received from up to eight external devices (such as an onboard analytics device), and permitting events to trigger external devices (such as a car alarm) to enter an alarm condition. An external GPS antenna socket 175 is also provided, permitting the device to use a dedicated vehicle mounted GPS antenna to provide the GPS receiver unit with a stronger signal for determining the position of the vehicle, or alternatively to make use of an external GPS receiver to determine the position of the vehicle. Additional camera inputs 180 are also provided, permitting further cameras to be coupled to the device 1 and further views insider or outside the vehicle to be captured. Internal to the first units 160 are a serial or USB connection for a GSM/3G/4G, WiFi or similar wireless interface, a high capacity back up battery for operation if the power is cut or when the vehicle is off, connections for 9 to 32V DC power input (from the vehicle) and a tamper switch on the rear.

Turning now to FIG. 2B, a rear view of the first unit 110 is schematically illustrated. The side of the first unit 110 shown in FIG. 2B is that which is visible to the driver, and therefore provides all of the parts of the device which the driver may need to interact with. For example, an emergency record button 132 is provided, which enables the driver to trigger the generation and sending of a reporting email regarding an emergency—this may be regarded as a “panic” button, which might be used in the event of a collision, or if the vehicle or driver is physically attacked. An overwrite LED indicator 134 is provided, which indicates if the content of the SD cards is being, or is about to be, overwritten. This gives the driver the opportunity to take steps to replace the SD cards. A trigger LED indicator 136 is also provided, and gives an indication that an event has been detected and that data relating to that event is being recorded into the SD cards. A format button 138 is also provided, to permit the driver to format the SD cards. An eCall button 140 is provided, to enable the driver to initiate 2 way voice communications with emergency services and/or his insurance company in the event of an accident or other incident. The 2 way voice communication makes use of the microphone and speaker 144. A set of “traffic light” LED indicators 142 for providing the driver with feedback on their driving style are also provided. 3 lights are used; Red, Amber and Green, which will light and visually show the G-forces (Driving Style) the unit is picking up to the driver of the vehicle. This will then encourage the driver to calm down any harsh driving. This encourages better fuel economy and safer driving. If the green LED is lit, this indicates that the driver is driving sensibly. An amber LED indicates that the driver's driving style is bordering on being too aggressive. The red LED indicates that the driver is driving too aggressively. The red LED may be a precursor to the sending of a driving event by email, or may happen in parallel with the sending of a driving event by email.

It will be appreciated that while certain elements of the notification device are described as being part of the first unit 110 and other elements of the notification device are described as being part of the second unit 160, certain of the elements could be provided in either unit. For example, while the camera, indicators, microphone and speaker and eCall and other buttons should be provided on the first unit for attachment to the windscreen, the accelerometer and RFID reader could readily be provided in the second unit if desired. It is strongly preferable that the SD cards be provided in the second unit 160, which can be hidden away inside the vehicle and made more difficult to access and tamper with.

The detection of events can either be carried out at the notification device itself, or at an event handler based on data provided to the event handler by the notification device. In both cases the notification device comprises an accelerometer, a positioning device and a camera which are used to capture data which can be used to detect and analyse driving events. Furthermore, in both cases an email handler is used to generate and send reporting emails to a target email address over the Internet. The difference between the two implementations resides in the information communicated in the reporting email, and the entity which carries out the detection of events based on the outputs of the accelerometer and/or positioning device.

### First Implementation

In a first implementation, one or both of the outputs from the accelerometer 7 and the positioning device 8 are compared, at the notification device itself, with at least one rule to determine whether an event has occurred. The at least one rule may be a threshold condition, such as a requirement that an acceleration force measured by the accelerometer exceeds a predetermined threshold. When it is determined at the notification device that an event has occurred, the email handler 3 is caused to generate and send an email which includes event information relating to the detected event. The event information may be image data captured at or around the time of the detected event, as well as the outputs of one or both of the accelerometer 7 and positioning device 8.

### Second Implementation

In a second implementation, the logic for detecting whether an event has occurred is not provided at the notification device, but is instead provided at an event handler, which might for example be a server. In this case the notification device itself reports the outputs of the accelerometer and the positioning device in reporting emails, but does not attempt to analyse the outputs itself to determine whether a driving event has occurred. The reporting emails may be sent on a regular basis, for example every 5 minutes or each time the vehicle is started up, or may be provided upon request by the event handler or another party. When the event handler receives the reporting email from the notification device, it compares the accelerometer and positioning device outputs carried in the email with at least one rule to determine whether an event has occurred.

It will be appreciated that the first implementation advantageously only transmits a reporting email when a driving event actually occurs. As a result, the amount of data transmitted is reduced, potentially saving costs where data usage is being paid for on a data volume basis. However, the first implementation requires significantly more processing capability and functionality to be provided at the notification device, increasing its complexity and cost. Further, it may be easier to update the rules and/or map data at an event handler when required than to update every single notification device to have the latest version of the rules and the latest set of map data.

The driver event notification device can be considered to comprise an accident event recorder, a facility for two-way telemetry communication, and a facility for email identification. The device has a communications port which can be connected to a WiFi, GSM, 3G, 4G or future communication method dongle, so that it can communicate with the world via Email. Existing off-the-shelf communication dongles can be used, and the use of email as a reporting and control mechanism removes the requirement to support a dedicated communications session between the notification device and a server device. There is no need for a fixed IP address from the mobile network. The notification device does not need a fixed IP address, since all communication is done via a unique email address dedicated to the notification device. As a result, any type of SIM card can be used, including Pay As You Go and Consumer SIMs, which typically provide cheaper data packages than Business SIMs or M2M (Machine to Machine) SIMs.

The notification device can be provided with intelligence, enabling it to send an email to a third party recipient when any of the following occur:
The vehicle exceeds a speed limit (which may be determined for the vehicle's current location, as obtained from the positioning device, from map data indicating a speed limit of the road which the vehicle is currently travelling on).
The vehicle is involved in an accident (detected based on an accelerometer output or other shock sensor)
An alarm input is triggered (for example the emergency record button 132 is pressed)
The accelerometer (G-force sensor) is triggered
Poor driving is detected (based on one or a sequence of events)
Unauthorised movement of vehicle, as determined by location or time

The reporting email may include text only, showing the vehicle registration number, time/date and information above. However, preferably compressed video is provided as an attachment, sent from the notification device at a low resolution and frame rate. For example, 10 seconds of video may have a data size of 100 kb to 150 kb. The original (uncompressed) video may be provided as an attachment. At a high resolution, 10 seconds of video may be approximately 10 MB. The reporting email to which this clip is attached may also contain GPS position, accelerometer output and Speed Information. It may also be watermarked and Time/Date stamped for use as evidence. It will be appreciated that the sending of uncompressed video on a routine basis may be too expensive due to the large volume of data required to be transmitted. In order to mitigate this problem, the notification device can be set up to send compressed video automatically when an event occurs, and then when this is verified as being a real event, by simply replying to the notification device by email address, the notification device will automatically send the original high resolution video in a subsequent reporting email.

The rules may depend on the type of vehicle. For example, a car may be expected to experience different forces during normal driving than a van or a lorry. Accordingly, the threshold acceleration values at which the accelerometer output is deemed to trigger a driving event may be different for different vehicles.

The accelerometer may output separate values for each of a first axis which is substantially parallel to a front-to-back axis of the vehicle, a second axis which is substantially parallel with a left to right axis of the vehicle and a third axis which is substantially parallel with an up-down axis of the vehicle. The forces measured in relation to the first axis give a measure of how fast the driver is accelerating (forward direction), and how hard they are braking (backward direction), and therefore how aggressively he is driving. A very high measured value of the first axis measurement may indicate a collision, and the direction (forward or backward) will indicate whether the collision was to the front or the rear of the vehicle.

The forces measured in relation to the second axis give an indication of how fast the driver is taking corners and therefore how aggressively he is driving. A very high measured value of the second axis measurement may indicate a collision, and the direction along the second axis will indicate whether the collision was from the left or the right of the vehicle. The forces measured in relation to the third axis give an indication of how carefully the driver is negotiating speed ramps or cattle grids, and therefore how aggressively he is driving. In addition, if the driver is travelling fast on a rough surface, this can be detected as many spikes in the third axis measurements, and can be used to provide an indication of wear and tear on the vehicle. It will therefore be appreciated that a type of event detected may be dependent on in relation to which of the first axis, second axis and third axis a threshold condition is satisfied. The vehicle-specific set of rules might be a specific set of threshold values for each of the first, second and third measurement axes of the accelerometer. In some cases, the threshold condition may be dependent on the speed of the vehicle. For example, a rate of turn (second axis) measured at a certain value may be considered safe at a low speed, but dangerous at a relatively high speed, and so the threshold condition at a higher speed may be lower than at a relatively low speed.

If a collision is detected, analytics information can be obtained from an on-board analytics unit installed in the vehicle. The analytics information may include an indication of whether an airbag has gone off and other information regarding the operation and performance of the vehicle before, during and after the accident.

It may also be possible for events to be generated based on analytics information from an onboard analytics device connected to the notification device. For example, analytics information often includes data on fuel economy and engine idling, which can provide an indication of driving style. In other words, the current fuel economy could be compared with a rule, and an event may be triggered to indicate to the driver and/or a third party such as an insurance provider that the driver is not driving in a sensible manner It will be appreciated that, if image data is provided with the event reporting email, a determination can be made of whether the driving style and thus the fuel economy were in fact appropriate having regard to the conditions on the road (poor fuel economy can be expected when a vehicle is crawling along in a traffic queue for example).

If a mobile signal cannot be found then the unit will buffer the events and image and other data until a mobile signal is found again. This ensures that no events are lost. The unit can also be set up to wait for a reply email (acknowledgement), before it assumes the events were successfully emailed

An alarm input is provided which can be connected to various devices, such as a panic button or vehicle alarm. When an alarm input is triggered, a reporting email is sent to an appropriate destination email address (which might be the driver's email address and/or the relevant authorities).

An alarm output is available which can be connected to third party devices, such as a siren or telematics unit. The third party device, which itself may not be capable of receiving notifications by email, may be directly notified of the occurrence of the event by way of this direct connection to the notification device, and in response to the notification may raise an alarm.

### False Event Detection & Driver Grading/Warning Server

Events detected by the notification device can be emailed to a False Event Detection Server, which can act as an intermediary between insurance companies and the emails being sent by the notification device. The server reviews the events (either automatically or with operator input) to determine if the events are real events or false events. This determination can be made for example by reviewing the image data in combination with the accelerometer and position data. If a high braking force is detected by the accelerometer, then this may or may not be deemed an incident of aggressive driving, depending on the camera footage. For example, if the camera footage shows that another vehicle had pulled out in front of the driver causing him to perform an emergency stop, then this may not be considered aggressive driving, whereas if the camera footage shows no extenuating circumstances then the event may be categorised as dangerous driving. The driver and their insurance company may in the former case receive no notification, while in the latter case may be emailed a notification of the event. Similarly, if a high speed is detected then it may be considered aggressive driving when the camera shows a significant amount of traffic on the road, but not if the camera shows a clear road ahead of the driver. An insurance company may provide a set of criteria against which events are compared, with only events meeting the specified criteria being passed on to the insurance company. The false event detection server can therefore reduce the number of false events (according to the clients definition of a false event), and then send only real events to them, all in a matter of seconds from when the event is detected. A regular log of driving data (G-force, Speed, Location) can be sent to the Driver Grading/Warning server and this will then analyse the data and report back to the insurer or client any drivers that are in breach of the parameters allowed by the insurer/client. It will be appreciated that the function of the false event detection and driver grading/warning server may be slightly different depending on whether or not the events are detected at the notification device, or at the server. In the former case event detection is carried out by applying a set of rules, and the resulting events are reviewed at the server, for example with respect to the captured image data, to identify real and false events. In the latter case the server both applies the rules and checks the resulting events against the image data to identify real and false events.

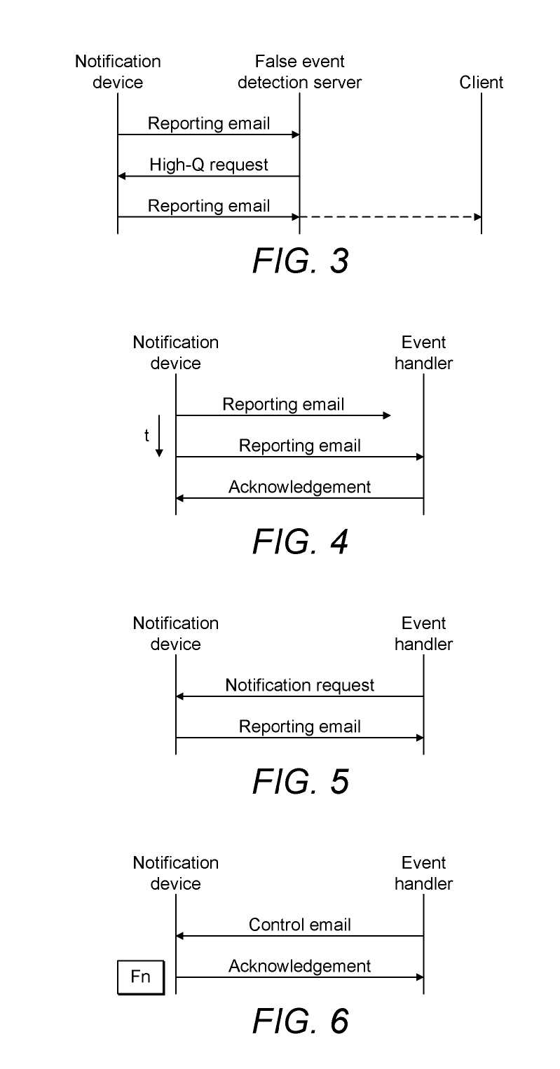

Referring to FIG. 3, a schematic signal flow diagram is provided. The signal flow diagram of FIG. 3 illustrates communication between a notification device, a false event detection server and a client device (for example a device associated with an insurance company). First, a reporting email is sent from the notification device to the false event detection server. The reporting email contains a low quality version of the video footage captured by the notification device's camera. The event information carried in the reporting email will be examined at the false event detection server, either automatically, or manually, or a combination of the two. If the event information carried in the reporting email is determined to relate to a “real” event rather than a “false” event, a high quality request email is sent from the false event detection server to the notification device. In response to the high quality request email, a further reporting email is sent from the notification device to the false event detection server and is then forwarded on to the client device. It will be appreciated that the reporting email sent in response to the high quality request email may be addressed directly to the client device rather than to the false event detection server, should this be required.

An example structure and content for an email requesting higher quality version of image data is provided below:
To: 444EY3299233@smartwitness.com
Subject: K121CKO_20130316_142230_Event_Alarm

This message tells notification device 444EY3299233 to provide a high quality version of the image data for the event at 14:22 on the 16 Mar. 2013.

Referring to FIG. 4, a schematic signal flow diagram illustrating the use of acknowledgement emails is provided. In FIG. 4, a first reporting email is shown not to reach an event handling device from the notification device. After a predetermined time period t, the notification device identifies that it has not received an acknowledgement email, and therefore resends the reporting email, which in the present case does reach the event handling device. In response to the reporting email the event handling device generates and sends to the notification device an acknowledgment email, the receipt of which will ensure that the reporting email is not resent.

As described previously, a reporting email may be triggered when the driving event notification device detects the occurrence of an event. So, for example when the notification device is triggered by a particular acceleration force (G-force) being detected by the accelerometer, then the email handler of the device will be caused to send an email to a destination email address or addresses. The destination address/s may be specified using PC software when setting up an SD card for insertion into the notification device.

A reporting email may comprise the following:

i. From: cameraserialnumber@smartwitness.com

ii. Subject: Vehicle Licence Plate—2013/03/16 14:22:30—Event Alarm

iii. Content: A list of data (for example 8 seconds of data prior to the detected event and 12 seconds of data following the event).

For example, for Camera Serial Number 444EY3299233, fitted in vehicle registration number K121 CKO, for an accident at 14:22 on 16th Mar. 2013:
From: 444EY3299233 @smartwitness.com
Subject: K121CKO_20130316_142230_Event_Alarm
Attachments: 10 second Video file (this will be low resolution, compressed and at 1 fps, and be from 14:22:33)
Content:

| | | | | Z- | |
|---|---|---|---|---|---|
| Time | Latitude, Longitude | X-force | Y-force | force | Speed |
| 14:22:24 | +51.569388, −0.155869 | 0.5 | 1.2 | 0.3 | 52 |
| 14:22:25 | +51.569388, −0.155869 | 0.8 | 1.3 | 0.4 | 53 |
| 14:22:26 | +51.569388, −0.155869 | 0.5 | 1.4 | 0.3 | 52 |
| 14:22:27 | +51.569388, −0.155869 | 0.8 | 1.3 | 0.3 | 55 |
| 14:22:28 | +51.569388, −0.155869 | 0.6 | 1.3 | 0.2 | 55 |
| 14:22:29 | +51.569388, −0.155869 | 0.8 | 1.4 | 0.3 | 55 |
| 14:22:30 | +51.569388, −0.155869 | 0.7 | 1.3 | 0.3 | 51 |
| 14:22:31 | +51.569388, −0.155869 | 0.8 | 1.4 | 0.3 | 45 |
| 14:22:32 | +51.569388, −0.155869 | 1.2 | 1.4 | 0.4 | 15 |
| 14:22:33 | +51.569388, −0.155869 | 1.6 | 1.6 | 0.7 | 8 |
| 14:22:34 | +51.569388, −0.155869 | 1.6 | 1.7 | 0.6 | 7 |
| 14:22:35 | +51.569388, −0.155869 | 0.5 | 0 | 0.1 | 0 |
| 14:22:36 | +51.569388, −0.155869 | 0 | 0 | 0 | 0 |
| 14:22:37 | +51.569388, −0.155869 | 0 | 0 | 0 | 0 |
| 14:22:38 | +51.569388, −0.155869 | 0 | 0 | 0 | 0 |
| 14:22:39 | +51.569388, −0.155869 | 0 | 0 | 0 | 0 |
| 14:22:40 | +51.569388, −0.155869 | 0 | 0 | 0 | 0 |
| 14:22:41 | +51.569388, −0.155869 | 0 | 0 | 0 | 0 |
| 14:22:42 | +51.569388, −0.155869 | 0 | 0 | 0 | 0 |
| 14:22:43 | +51.569388, −0.155869 | 0 | 0 | 0 | 0 |

The entry corresponding to the time of the detected event is 14.22.33 (highlighted entry). The x-force at this time reaches 1.6, which exceeds a collision threshold. A review of the data entries from above reveals that the vehicle was decelerating rapidly (see speed column—determined from the positioning device) just before this time, and all of the accelerometer forces spiked. The camera footage could be reviewed to confirm the occurrence and nature of the collision.

Referring to FIG. 5, a schematic signal flow diagram illustrating the sending of reporting emails on demand is provided. In FIG. 5, a notification request email is sent from the event handler to the notification device. In response to the notification request email, the notification device generates and sends a notification email to the event handler. The notification request email may specify a period of time which the notification email is intended to cover, in which case the reporting email will contain either a list of events which were detected during the specified time period along with image data and accelerometer and positioning device outputs relating to those events (first implementation) or simply a log of outputted output values from the accelerometer and positioning device (second implementation). The notification request email may specify an image resolution, in which case the reporting email will be generated containing the requested image data at the requested resolution. In the case that the camera device is a video camera device which captures a video recording of a scene, the request email may specify a frame rate, in which case the reporting email will be generated containing the requested image data (video recording) at the requested frame rate. In this way, it is possible to request recordings from the notification device by sending it an email with the time/date from and time/date to that you would like to see, along with the resolution and frame rate at which you would like to view it.

Referring to FIG. 6, a schematic signal flow diagram illustrating the use of emails to control the operation of the notification device is provided. In FIG. 6, a control email is sent from the event handler (or another external device) to the notification device. The control email contains one or more instructions to carry out one or more functions. Examples of functions which may be triggered by a control email include the initiation of a 2 way voice communications session between the driver and an outside agency or person using the microphone and speaker 114, a self-test function or an externally controlled reset function. Once the control email has been received at the notification device and/or when the function has been completed, an acknowledgement email is sent from the notification device to the event handler.

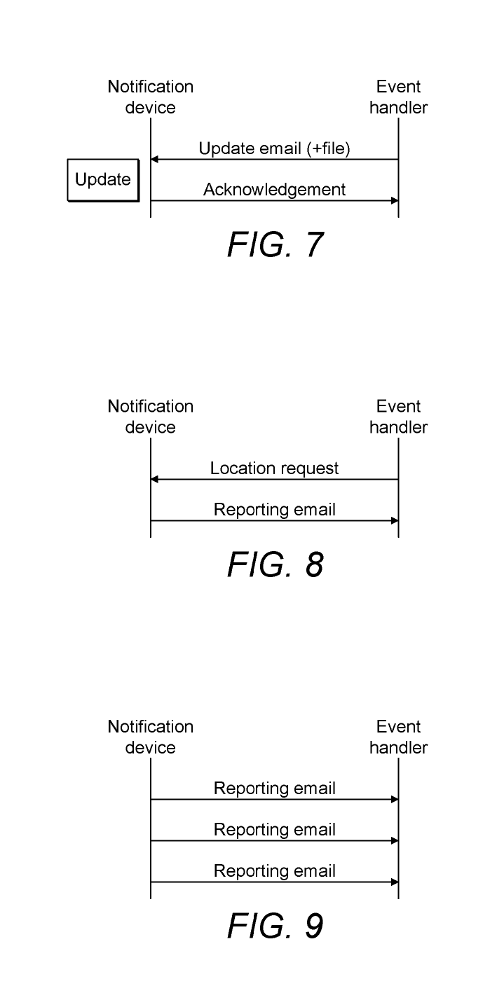

Referring to FIG. 7, a schematic signal flow diagram illustrating the use of emails to carry out firmware updates or to update hardware or software settings is provided. In FIG. 7, an update email, optionally with an executable file or update library attached, is sent from the event handler (or another external device) to the notification device. The update email specifies an update which needs to be carried out by the notification device, and provides the data (for example files or parameters) which are required for the update. As an example, the update may be a firmware update, and a file to be executed or otherwise used to achieve the firmware update is attached to the email The notification device is responsive to the receipt of the update email to update its firmware based on the firmware update file attached to the update email In another example, the update is a settings update for updating hardware or software settings of the device. A hardware setting might be the sensitivity of the accelerometer, or a camera setting. A software setting might be an update to the rules used to determine whether an event has occurred—for example a change in a threshold condition used to detect an accident impact, or an update to map data used along with the rules. As with FIG. 6, once the update email has been received at the notification device and/or when the update has been completed, an acknowledgement email is sent from the notification device to the event handler.

Referring to FIG. 8, a schematic signal flow diagram illustrating the use of emails to request a current location of the vehicle is provided. In FIG. 8, an event handler (or another external device) seeking to track the location of the vehicle may request a current location of the vehicle by sending a location request email to the notification device. When a location request email is received at the notification device, a reporting email containing the current location of the vehicle is generated and sent to the requesting device.

An example structure and content of an email requesting a location update for the vehicle is shown below:

An example for Camera Serial Number 444EY3299233
To: 444EY3299233 @smartwitness.com
Subject: Location

This tells notification device 444EY3299233 to report the current location of the vehicle.

Referring to FIG. 9, a schematic signal flow diagram illustrating the use of emails to provide regular reporting of either current location or other event-related data is provided. In this case, the notification device sends regular reporting emails to an event handler (or another external device). The regular reporting email may be a current location of the vehicle, thereby providing a vehicle tracking function, or a log of recently detected events (first embodiment) or a log of outputs of the accelerometer and/or positioning device and/or other sensors.

Vehicle location tracking may be important where the use of a vehicle is restricted to particular times or locations. For example, a driver may only be insured to drive a vehicle within the UK, or a driver may be required to leave the vehicle at a certain location (e.g. a depot) at certain times (e.g. at night). A regular reporting email may be used to monitor this (with the logic for determining a breach being conducted away from the notification device), or alternatively the notification device may include the relevant rules to determine whether one of these conditions has been breached, in which case a reporting email may be generated and sent to indicate the breach.

1. A driving event notification device, comprising:
an accelerometer for detecting forces experienced by a vehicle;
a positioning device for determining the position of the vehicle;
a camera for generating image data;
a processor, for detecting the occurrence of a driving event by comparing the outputs of one or both of the accelerometer and the positioning device with at least one rule;
a communications port, for establishing a connection with the Internet;
an email handler using an email address dedicated to the driving event notification device, for generating a reporting email containing event information concerning the detected event and image data generated by the camera at or around the time of occurrence of the detected event, and sending the reporting email over the Internet via the communications port to a destination email address; and
wherein the processor is responsive to the detection of the occurrence of the event to cause the email handler to generate the reporting email and send it over the Internet to the destination email address.

2. A driving event notification device, comprising:
an accelerometer for detecting forces experienced by a vehicle;
a positioning device for determining the position of the vehicle;
a camera for generating image data;
a communications port, for establishing a connection with the Internet; and
an email handler using an email address dedicated to the driving event notification device, for generating a reporting email containing the outputs of one or both of the accelerometer and the positioning device and image data generated by the camera at or around the time of output of the outputs of the accelerometer and/or the positioning device, and sending the reporting email over the Internet via the communications port to a destination email address.

3. The notification device according to claim 1, wherein the processor is responsive to the receipt of a control email addressed to the dedicated email address and received at the email handler over the Internet to initiate or control a function of the notification device.

4. The notification device according to claim 1, comprising an attachment part arranged to receive a detachable communications dongle, wherein the communications port is operable to use the communications dongle to establish the connection with the Internet.

5. The notification device according to claim 1, comprising a data store for storing the outputs of the accelerometer and the positioning device, and the image data generated by the camera.

6. The notification device according to claim 5, wherein the processor is responsive to a request received by email at the email handler to obtain the stored outputs and image data corresponding to a time period specified in the request email, and to cause the email handler to generate and send to a target email address a reporting email containing the requested stored outputs and image data.

7. The notification device according to claim 6, wherein the request email specifies an image resolution, and the processor causes the email handler to generate and send to a target email address a reporting email containing the requested image data at the requested resolution.

8. The notification device according to claim 6, wherein the camera device is operable to capture a video recording of a scene and the request email specifies a frame rate, the processor causing the email handler to generate and send to a target email address a reporting email containing the requested video recording at the requested frame rate.

9. The notification device according to claim 1, wherein the reporting email carries a reduced quality version of image data captured by the camera at or around the time of occurrence of a detected event.

10. The notification device according to claim 9, wherein the reduced quality version of the image data is at least one of reduced in resolution, reduced in frame rate, and at a higher level of compression.

11. The notification device according to claim 9, wherein the processor is responsive to the receipt at the email handler of a request for a higher quality version of the image data sent in the reporting email, to cause the email handler to generate and send a further reporting email carrying a higher quality version of the image data sent in the reporting email.

12. The notification device according to claim 11, wherein the higher quality version of the image data is one or both of watermarked and time/date stamped.

13. The notification device according to claim 1, wherein the camera device is mounted to capture a scene similar to that viewed by the driver of the vehicle to which the notification device is mounted.

14. The notification device according to claim 1, wherein an event is detected when the accelerometer outputs a value which satisfies a threshold condition specified in the at least one rule.

15. The notification device according to claim 14, wherein the event is a collision, and the collision event is detected when the accelerometer outputs a value which exceeds a collision threshold.

16. The notification device according to claim 14, wherein the event is an incident of aggressive driving, and the aggressive driving event is detected when the accelerometer outputs at least one value which exceeds an aggressive driving threshold.

17. The notification device according to claim 14, wherein the accelerometer outputs separate values for each of a first axis which is substantially parallel to a front-to-back axis of the vehicle, a second axis which is substantially parallel with a left to right axis of the vehicle and a third axis which is substantially parallel with an up-down axis of the vehicle.

18. The notification device according to claim 17, wherein a type of event detected is dependent on in relation to which of the first axis, second axis and third axis the threshold condition is satisfied.

19. The notification device according to claim 14, wherein the threshold condition is dependent on the speed of the vehicle.

20. The notification device according to claim 1, wherein the positioning device determines at least one of the speed of the vehicle, the direction of travel of the vehicle and the position of the vehicle.

21. The notification device according to claim 1, comprising a two way audio device which is operable to establish a voice channel to the driver via the communications port and the Internet.

22. The notification device according to claim 1, wherein an event is detected when the speed of the vehicle is determined from the output of the positioning device to exceed a threshold value specified in the at least one rule.

23. The notification device according to claim 1, wherein the event is the unauthorised movement of the vehicle, detected based on one or both of the location of the vehicle and the time the vehicle is being driven.

24. The notification device according to claim 1, the reporting email is a text email comprising at least one of the vehicle registration number, an indication of the detected event, and a date/time of occurrence of the detected event.

25. The notification device according to claim 1, wherein the notification device comprises a driving style indicator, wherein the processor controls the driving style indicator to display to the driver an indication of their current driving style based on the output of the accelerometer.

26. The notification device according to claim 1, wherein the processor is operable to cause the email handler to generate and send a reporting email indicating a current location of the vehicle at predetermined time intervals.

27. The notification device according to claim 1, wherein the processor is responsive to a location requesting email received at the email handler to cause the email handler to generate and send a reporting email indicating a current location of the vehicle.

28. The notification device according to claim 1, wherein the processor is responsive to a firmware update received via email at the email handler to update the firmware of the notification device using the firmware update.

29. The notification device according to claim 1, wherein the processor is responsive to a settings update control email to update software or hardware settings of the notification device.

30. The notification device according to claim 29, wherein the software settings comprise the rules used to determine whether an event has occurred.

31. The notification device according to claim 1, wherein, if a connection with the Internet cannot be established by the communications port, the processor is operable to cause detected events and/or the outputs of the accelerometer and positioning device to be buffered until a connection with the Internet can be reestabished.

32. The notification device according to claim 1, wherein, if a confirmation receipt email is not received at the email handler from the destination email address within a predetermined time period from when a reporting email is sent, the email handler is operable to resend the reporting email.

33. The notification device according to claim 1, comprising a tamper switch, wherein the processor is responsive to the actuation of the tamper switch to cause the email handler to generate and send a tamper alert email to a destination email address.

34. The notification device according to claim 1, wherein the notification device comprises an identification device for verifying the identity of a driver of the vehicle, wherein the processor is operable to cause the email handler to generate and transmit an alert email if an unauthorised person enters or attempts to drive the vehicle.

35. The notification device according to claim 34, wherein the identification device is an RFID reader, and the identification device verifies the identity of the driver of the vehicle based on the detection of an RFID card or tag carried by the driver.

36. A false event detection server for receiving reporting emails from a notification device according to claim 1, the false event detection server being associated with the destination email address, the false event detection server comprising:
an email handler using the destination email address; and
a processor, operable to compare the event information in the reporting email with a client event definition to determine whether the event information relates to a real event or a false event, and to cause the email handler to forward the reporting email to a client email address only if the reporting email is determined to be a real event.

37. The false event detection server according to claim 36, wherein the reporting email received at the email handler of the false event detection server carries image data at a reduced quality, and the processor of the false event detection server is operable, when the event information in the reporting email is determined to relate to a real event, to send an email request to the notification device to provide a higher resolution version of the image data corresponding to the event.

38. The event detection server for receiving reporting emails from a notification device according to claim 2, the event detection server being associated with the destination email address, the event detection server comprising:
an email handler using the destination email address; and
a processor operable to detect the occurrence of a driving event by comparing at least one of the accelerometer and positioning device outputs carried in the reporting email with at least one rule.

39. The false event detection server according to claim 38, wherein the reporting email received at the email handler of the false event detection server carries a video image at a reduced resolution, and the processor of the false event detection server is operable, when an event is detected in the accelerometer and/or positioning device outputs carried in the reporting email, to send an email request to the notification device to provide a higher resolution version of the video image corresponding to the event.

40. The event handling system, configured to receive reporting emails from a notification device according to claim 1.

41. The event handling system according to claim 40, wherein the system is operable to identify the notification device based on the dedicated email address from which the reporting email is received.

42. A driving event notification method, comprising the steps of:
detecting forces experienced by a vehicle;
determining the position of the vehicle;
generating image data;
detecting the occurrence of a driving event by comparing the detected forces and/or the determined position with at least one rule;
establishing a connection with the Internet;
using an email address dedicated to the driving event notification device, generating a reporting email containing event information concerning the detected event and image data generated at or around the time of occurrence of the detected event, and sending the reporting email over the Internet to a destination email address; and
wherein the generation and sending of the reporting email is responsive to the detection of the occurrence of the event.

43. A driving event notification method, comprising the steps of:
detecting forces experienced by a vehicle;
determining the position of the vehicle;
generating image data;
establishing a connection with the Internet;
using an email address dedicated to the driving event notification device, generating a reporting email containing at least one of the detected forces and the position of the vehicle and image data generated at or around the time of detection of the forces and/or the determined vehicle position, and sending the reporting email over the Internet to a destination email address.

44. A driving event notification method, comprising the steps of:
receiving the reporting email at the destination email address; and
detecting the occurrence of a driving event by comparing the detected forces and/or the vehicle position carried in the reporting email with at least one rule.

45. The computer program which when executed on a computer will cause the computer to perform a method according to claim 42.

46-49. (canceled)
